(19) United States
(12) Patent Application Publication
(10) Pub. No.: US 2024/0211266 A1
(43) Pub. Date: Jun. 27, 2024

(54) INFORMATION PROCESSING APPARATUS AND METHOD OF PROCESSING INFORMATION

(71) Applicant: Fujitsu Limited, Kawasaki-shi (JP)

(72) Inventors: Yi Ge, Bunkyo (JP); Takahide Yoshikawa, Kawasaki (JP)

(73) Assignee: Fujitsu Limited, Kawasaki-shi (JP)

(21) Appl. No.: 18/375,124

(22) Filed: Sep. 29, 2023

(30) Foreign Application Priority Data
Dec. 22, 2022 (JP) 2022-206073

(51) Int. Cl. G06F 9/38

(52) U.S. Cl. CPC G06F 9/3867

(57) ABSTRACT

An information processing apparatus includes: a storage apparatus including a plurality of banks used as respective separate storage regions; a pipeline having a plurality of lanes in each of which processing of an instruction for reading or writing data from or to the bank is performed; a plurality of instruction processing circuits that are respectively disposed in the lanes, each access any of the banks in accordance with the instruction processed in the corresponding lane, and each execute reading or writing of data; a blocking network switch configured to selectively couple the instruction processing circuit to any one of the banks by switching a coupling path.

### CROSS-REFERENCE TO RELATED APPLICATION

This application is based upon and claims the benefit of priority of the prior Japanese Patent Application No. 2022-206073, filed on Dec. 22, 2022, the entire contents of which are incorporated herein by reference.

### FIELD

The embodiments discussed herein are related to an information processing apparatus and a method of processing information.

### BACKGROUND

A processor that executes a plurality of instructions in one cycle by using instruction-level parallelism has been researched and developed in recent years. An instruction issue width of a processor tends to increase in order to extract more instruction-level parallelism. In order to extract data-level parallelism, a number of single instruction multiple data (SIMD) instructions that process a plurality of pieces of data with one instruction tends to increase. A program executed by a processor includes many load instructions or many store instructions. A load-store instruction of the SIMD instruction includes a gather instruction or a scatter instruction that perform load processing or store processing on a plurality of discontinuous addresses. For this reason, in a processor that issues multiple instructions or has the SIMD instructions, a frequency at which the load instruction or the store instruction to a plurality of addresses is issued in one cycle is high, and a data cache that meets this demand is demanded. For this reason, multi-porting of data caches is being developed in the processors in recent years.

U.S. Patent Application Publication No. 2022/0171731 and Japanese Laid-open Patent Publication No. 2017-016637 are disclosed as related art.

### SUMMARY

According to an aspect of the embodiments, an information processing apparatus includes: a storage apparatus including a plurality of banks used as respective separate storage regions; a pipeline having a plurality of lanes in each of which processing of an instruction for reading or writing data from or to the bank is performed; a plurality of instruction processing circuits that are respectively disposed in the lanes, each access any of the banks in accordance with the instruction processed in the corresponding lane, and each execute reading or writing of data; a blocking network switch configured to selectively couple the instruction processing circuit to any one of the banks by switching a coupling path; a conflict detection circuit configured to, in a case where two or more of the instruction processing circuits access the bank, detect a conflict location of the access based on information on an access destination and information on the coupling path of the blocking network switch, and determine a switching state of the blocking network switch and a stalled lane in which the processing is to be stopped from among the plurality of lanes based on the detected conflict location; a pipeline control circuit configured to perform pipeline control for stopping the access to the bank from the instruction processing circuit corresponding to the stalled lane determined by the conflict detection circuit; and a switch control circuit configured to switch the blocking network switch in accordance with the switching state determined by the conflict detection circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a CPU according to a first embodiment;

FIG. 2 is a diagram illustrating an overview of a table held by a conflict detection unit according to the first embodiment;

FIG. 3 is a diagram illustrating a simple example of the table held by the conflict detection unit according to the first embodiment in a case of two inputs and two outputs;

FIG. 4 is a diagram illustrating an overview of one switch among a plurality of switches included in a blocking network switch;

FIG. 5 is a diagram illustrating an example of a configuration of a conflict detection unit and a switch control unit;

FIGS. 6A and 6B are a diagram illustrating an example of a table included in a conflict detection unit in a case where switches are provided in two stages;

FIG. 7 is a diagram illustrating an example of determination of a switch switching state and a stalled lane according to the first embodiment;

FIG. 8 is a flowchart of instruction fetch processing;

FIG. 9 is a flowchart of switch control and pipeline control by an access control unit according to the first embodiment;

FIG. 10 is a diagram illustrating a comparison between circuit scales of a crossbar switch and an omega network switch;

FIG. 11 is a block diagram of a CPU according to a second embodiment;

FIG. 12 is a diagram illustrating an example of determination processing of a priority order for each lane of a pipeline according to the second embodiment;

FIG. 13 is a diagram illustrating an overview of access control processing performed by an access control unit according to the second embodiment;

FIG. 14 is a diagram illustrating an example of determination of a switch switching state and a stalled lane in consideration of a number of held instructions;

FIG. 15 is a flowchart of switch control and pipeline control by the access control unit according to the second embodiment;

FIG. 16 is a diagram illustrating an example of a case where a priority order is determined by using a number of held instructions of each of input side and output side FIFO queues; and

FIG. 17 is a flowchart of switch control and pipeline control by an access control unit according to a second modification example.

### DESCRIPTION OF EMBODIMENTS

As a method for multi-porting data caches, multi-banking has been attracting attention. In the multi-banking, a data cache is divided into a plurality of storage regions called banks, and a port is prepared for each bank. Accordingly, in a case where a processor accesses different banks, it is possible to simultaneously respond to requests for a plurality of load instructions or store instructions. There may be a case where a multi-banked primary data cache is referred to as a multi-bank level 1 data cache (MBL1D).

When a central processing unit (CPU) is equipped with the multi-bank level 1 data cache, data transfer is performed between a load-store unit that performs a plurality of loads and stores and a plurality of banks included in the multi-bank level 1 data cache. By using a non-blocking network such as a crossbar switch for coupling between each load-store unit and each bank, an access conflict other than a bank conflict generated by a plurality of instructions destined for the same bank does not occur, and thus efficiency of data transfer is improved. The non-blocking network is a switch configuration in which arbitrary couplings to different destinations may be simultaneously realized. However, when the non-blocking network is used, there is a disadvantage that a circuit scale increases.

Conversely, in order to suppress the circuit scale, it is advantageous to use a blocking network. The blocking network is a switch configuration in which there may be a case where simultaneous coupling to different destinations is not realized. Examples of the blocking network include an omega network, a banyan network, an indirect binary n-cube, and the like. However, in a case where the blocking network is used, as the access conflict, a conflict between switches in which different accesses pass through a same path occurs in addition to the bank conflict, and thus there is a risk that efficiency of data transfer decreases. Hereinafter, the conflict between accesses in the switches is referred to as a “switch conflict”.

A technique for avoiding a conflict by a method such as self-rooting or non-blocking has been proposed in a case where the blocking network is used. A technique has been proposed in which, in a case where a plurality of instructions for a plurality of memory banks are issued and a data hazard occurs, processing is continued by using a data hazard resolving logic such as a vector shift operation.

However, in a configuration of a CPU of the related art that is not equipped with the multi-bank level 1 data cache, when a bank conflict occurs, all instructions subsequent to a next instruction are canceled and reissued. For this reason, in a case where the non-blocking network and the multi-bank level 1 data cache are simply equipped in the configuration of the CPU in the related art, all instructions after the bank conflict are canceled. Since the bank conflict frequently occurs in the multi-bank level 1 data cache, performance degradation of the CPU increases in such a configuration. In a case where a blocking network is used instead of the non-blocking network, a switch conflict occurs in addition to the bank conflict, and thus there is a risk that the performance degradation of the CPU becomes larger than that in a case where the non-blocking network is used.

In this regard, a combination of the blocking network and the multi-bank level 1 data cache is not considered in a technique for continuing processing by using the data hazard resolving logic when a data hazard occurs. For this reason, even when this technique is used, it is difficult to suppress the performance degradation of the CPU equipped with the non-blocking network and the multi-banked primary data cache.

The disclosed technology has been made in view of the above discussion, and an object of the disclosed technique is to provide an information processing apparatus and a method of processing information that reduce a circuit scale while suppressing performance degradation.

Hereinafter, embodiments of an information processing apparatus and a method of processing information disclosed in the present application will be described in detail with reference to the drawings. Embodiments described below are not intended to limit the information processing apparatus and the method of processing information disclosed in the present application.

### First Embodiment

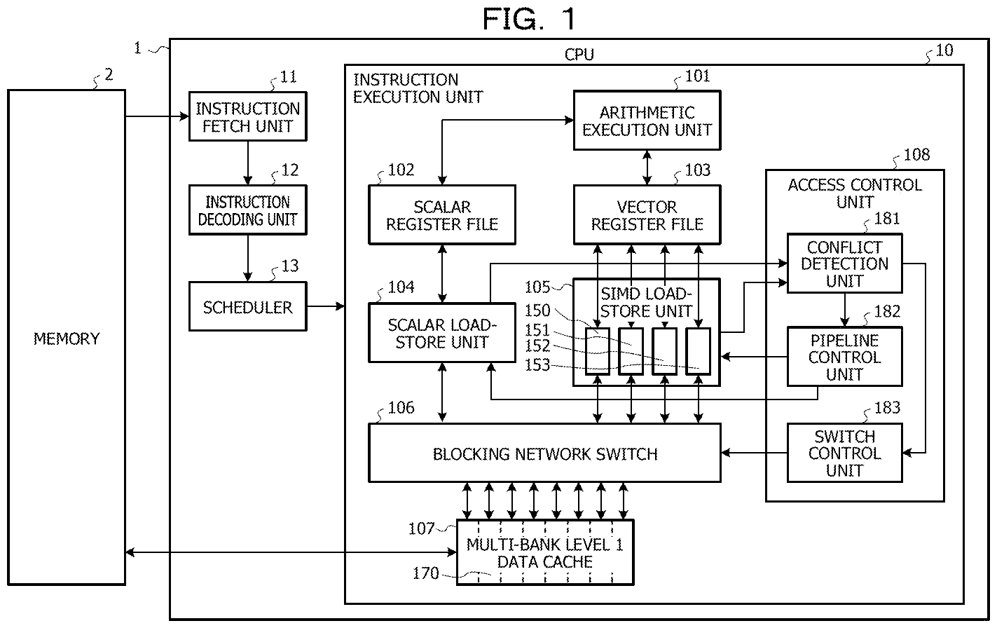

FIG. 1 is a block diagram of a CPU according to a first embodiment. A CPU 1 is coupled to a memory 2 that is a main memory. The CPU 1 processes instructions by pipeline processing. The CPU 1 includes an instruction execution unit 10, an instruction fetch unit 11, an instruction decoding unit 12, and a scheduler 13.

The CPU 1 is an example of an “information processing apparatus”. The instruction execution unit 10, the instruction fetch unit 11, the instruction decoding unit 12, and the scheduler 13 that process each instruction in stages correspond to a pipeline, and a path that processes an individual memory access corresponds to a lane. For example, since the pipeline according to the present embodiment processes a plurality of memory accesses in parallel, the pipeline has a plurality of lanes.

According to an address designated by a program counter, the instruction fetch unit 11 acquires an instruction stored in the memory 2. The instruction fetch unit 11 outputs the acquired instruction to the instruction decoding unit 12. A case where the instruction fetch unit 11 acquires a load instruction and a store instruction will be described.

The instruction decoding unit 12 receives an input of the instruction from the instruction fetch unit 11. The instruction decoding unit 12 decodes the instruction into a format processable by the instruction execution unit 10. After that, the instruction decoding unit 12 outputs the decoded instruction to the scheduler 13.

The scheduler 13 receives an input of the decoded instruction. Next, the scheduler 13 performs scheduling such as parallel execution of instructions. According to the determined scheduling, the scheduler 13 outputs the instruction to the instruction execution unit 10.

The instruction execution unit 10 receives an input of the scheduled instruction from the scheduler 13. According to the instruction, the instruction execution unit 10 loads and stores data. Hereinafter, the instruction execution unit 10 according to the present embodiment will be described in detail. As illustrated in FIG. 1, the instruction execution unit 10 includes an arithmetic execution unit 101, a scalar register file 102, a vector register file 103, a scalar load-store unit 104, and a single instruction multiple data (SIMD) load-store unit 105. The instruction execution unit 10 includes a blocking network switch 106, a multi-bank level 1 data cache 107, and an access control unit 108.

Although a case where the CPU 1 uses the SIMD load-store unit 105 to process a SIMD instruction is described in the present embodiment, the SIMD instruction does not have to be processed. For example, the CPU 1 may be configured to process a plurality of scalar instructions in parallel by using a plurality of scalar load-store units 104.

The multi-bank level 1 data cache 107 is a multi-banked primary data cache having a plurality of banks 170. Although FIG. 1 illustrates a configuration in which the multi-bank level 1 data cache 107 includes eight banks 170, the number of banks 170 is not limited. Each bank 170 is capable of independently processing a memory access request. The multi-bank level 1 data cache 107 is an example of a “storage apparatus”.

The blocking network switch 106 is a switch having a blocking network. Even when the accesses are destined for different banks in the blocking network switch 106, a conflict may occur between the accesses depending on a switch switching state.

According to the present embodiment, a case where the blocking network switch 106 is an omega network will be described. In the omega network, a plurality of switches that selectively couple two inputs and two outputs in a direct connection or by exchange are arranged in parallel, and columns thereof are arranged in a plurality of stages. A network configuration is provided in which switches of previous and subsequent stages are coupled such that a first input may be selectively connected to any of all outputs by switching of each switch.

The scalar register file 102 stores data of a scalar instruction input from the scheduler 13. The vector register file 103 stores data of a vector instruction input from the scheduler 13.

The scalar load-store unit 104 corresponds to one lane of the pipeline. Hereinafter, the lane corresponding to the scalar load-store unit 104 is referred to as a lane L. The scalar load-store unit 104 has one input side first in first out (FIFO) queue. The scalar load-store unit 104 has one output side FIFO queue. A method for suppressing performance degradation due to a bank conflict by adding a FIFO queue to a pipeline of a processor has been proposed in Japanese Laid-open Patent Publication No. 2022-143544. The scalar load-store unit 104 accesses one of the banks 170 held by the multi-bank level 1 data cache 107 and loads or stores data in accordance with an instruction.

For example, the scalar load-store unit 104 acquires a scalar instruction to be loaded or stored from the scalar register file 102 and accumulates the scalar instruction in the input side FIFO queue. Unless an instruction to stop access is input from the access control unit 108, the scalar load-store unit 104 outputs, to the blocking network switch 106, requests indicated by instructions in chronological order among the instructions stored in the input side FIFO queue in accordance with a cycle.

After that, the scalar load-store unit 104 receives a response from the multi-bank level 1 data cache 107 as a result of loading or storing data in accordance with the request via the blocking network switch 106. The scalar load-store unit 104 stores and accumulates the received response in the output side FIFO queue. After that, the scalar load-store unit 104 outputs instructions in chronological order among the instructions stored in the respective output side FIFO queues to the scalar register file 102 and stores the instructions therein. The scalar load-store unit 104 is an example of an “instruction processing unit”.

The SIMD load-store unit 105 processes memory access for each pipeline, corresponding to a plurality of lanes of the pipeline. In the present embodiment, the SIMD load-store unit 105 separately processes instructions in each of the four lanes of the pipeline. FIG. 1 illustrates processing functions corresponding to the respective lanes in the SIMD load-store unit 105 as respective lane processing units 150 to 153. In the following description, the lanes corresponding to the respective lane processing units 150 to 153 are referred to as lanes L0 to L3. The lane processing units 150 to 153 are an example of an “instruction processing unit”.

Each of the lane processing units 150 to 153 has one input side FIFO queue. Each of the lane processing units 150 to 153 has one output side FIFO queue. Each of the lane processing units 150 to 153 accesses one of the banks 170 held by the multi-bank level 1 data cache 107 and loads or stores data in accordance with an instruction.

For example, each of the lane processing units 150 to 153 acquires a scalar instruction to execute loading or storing from the vector register file 103, and accumulates the scalar instruction in its own input side FIFO queue. Unless a stall instruction is input from the access control unit 108, the lane processing units 150 to 153 output requests the instructed by instructions in chronological order among the instructions stored in the input side FIFO queue to the blocking network switch 106 in accordance with the cycle.

After that, each of the lane processing units 150 to 153 receives a response from the multi-bank level 1 data cache 107 as a result of loading or storing data in accordance with the request via the blocking network switch 106. The lane processing units 150 to 153 store and accumulate the received responses in each of the output side FIFO queues. After that, the lane processing units 150 to 153 output the instructions in chronological order among the instructions stored in the respective output side FIFO queues to the vector register file 103 and store the instructions therein.

The access control unit 108 controls access to the bank 170 from the scalar load-store unit 104 and the SIMD load-store unit 105 so that a switch conflict in the blocking network switch 106 and a bank conflict in the multi-bank level 1 data cache 107 do not occur. The access control unit 108 includes a conflict detection unit 181, a pipeline control unit 182, and a switch control unit 183.

The conflict detection unit 181 holds information on each of coupling paths between the scalar load-store unit 104 and the lane processing units 150 to 153, and the banks 170 in the blocking network switch 106. For example, the conflict detection unit 181 holds information on a combination of coupling paths in which a switch conflict occurs in a case where accesses simultaneously occur between the coupling paths coupling the scalar load-store unit 104 and the lane processing units 150 to 153, and the banks 170. The conflict detection unit 181 holds a priority order of access permission for each of the lanes L0 to L3 corresponding to each of the scalar load-store unit 104 and the lane processing units 150 to 153 in advance. For example, the conflict detection unit 181 gives a priority order of access permission in ascending order of a lane number. In the case of the present embodiment, the conflict detection unit 181 holds the priority order of access permission such that priority is given in ascending order of the lane L, a lane L0, a lane L1, a lane L2, and a lane L3 with a lane number of the lane L as a minimum. Hereinafter, the priority order of access permission is simply referred to as a priority order.

Alternatively, the conflict detection unit 181 may switch the priority order for each cycle. For example, the conflict detection unit 181 determines the priority order such that the priority order decreases in the order of the lane L, the lane L0, the lane L1, the lane L2, and the lane L3. In the next cycle, the conflict detection unit 181 determines the priority order of access permission such that the priority order decreases in the order of the lane L0, the lane L1, the lane L2, the lane L3, and the lane L. As described above, the conflict detection unit 181 may determine the priority order by traveling around the lanes.

The conflict detection unit 181 acquires information on access to be performed next from each of the scalar load-store unit 104 and the lane processing units 150 to 153. The conflict detection unit 181 checks the bank 170 of the access destination included in the access information, and determines that a bank conflict occurs when there is access to the same bank 170 as the destination. The conflict detection unit 181 checks the coupling path between the bank 170 of each access destination included in the access information and each of the scalar load-store unit 104 and the lane processing units 150 to 153, and determines whether a switch conflict occurs.

When either or both of the bank conflict and the switch conflict occur, the conflict detection unit 181 determines a stalled lane from the lanes of the pipeline corresponding to the lane L and the lanes L0 to L3 in accordance with the priority order so that the conflict does not occur. For example, the conflict detection unit 181 determines a lane having a low priority order as a stalled lane so that a lane having a high priority order may be used as much as possible. The conflict detection unit 181 determines a switching state of the blocking network switch 106 such that a lane other than the stalled lane is coupled to the bank 170 of the access destination.

After that, the conflict detection unit 181 outputs stalled lane information indicating the stalled lane to the pipeline control unit 182. The conflict detection unit 181 outputs switch control information including information on a switch switching state in accordance with the combination of the scalar load-store unit 104 and the lanes L0 to L3, and the banks 170 to be coupled, to the switch control unit 183.

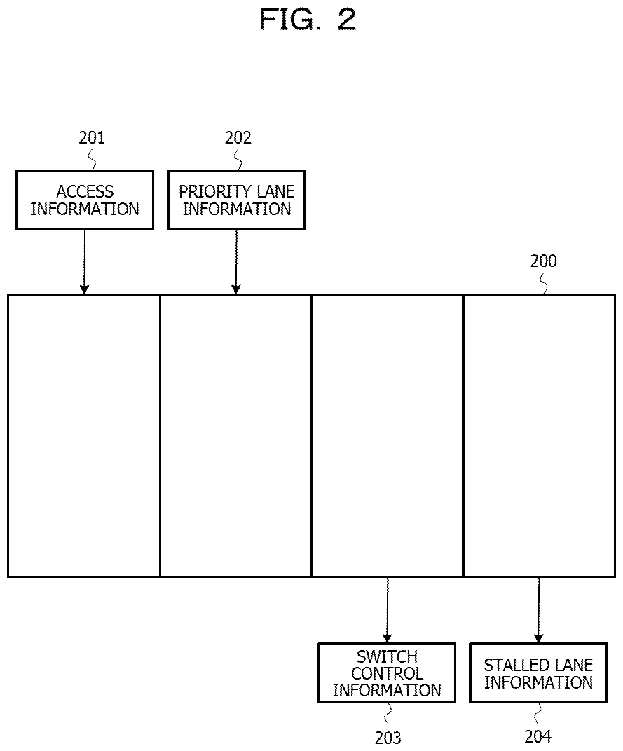

For example, FIG. 2 is a diagram illustrating an overview of a table held by a conflict detection unit according to the first embodiment. For example, the conflict detection unit 181 holds a table 200 in which information on an access destination and information on a lane to be prioritized are registered. In the table 200 illustrated in FIG. 2, the information on the access destination of each lane is registered in a column corresponding to access information 201. In the table 200 in FIG. 2, the information on the lane to be prioritized is registered in a column corresponding to priority lane information 202. The table 200 in FIG. 2 has a column including a switch switching state corresponding to each combination of each access destination and the information on the lane to be prioritized, and a column including information on a stalled lane. By using the access information 201 and the priority lane information 202, the conflict detection unit 181 searches the table 200 and outputs switch control information 203 and stalled lane information 204.

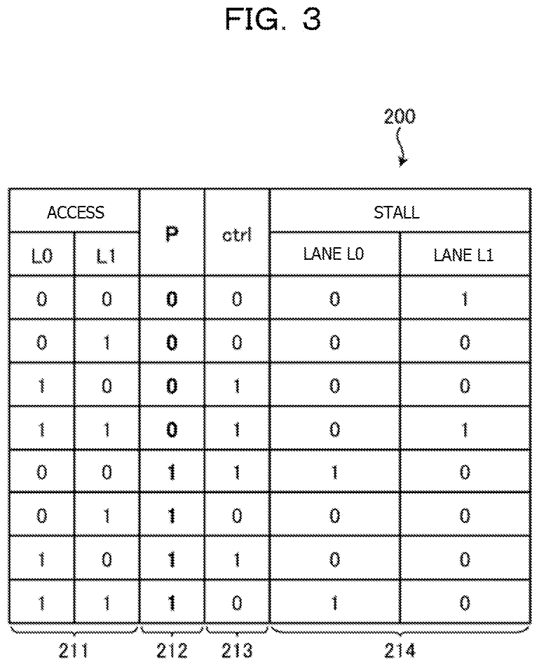

FIG. 3 is a diagram illustrating a simple example of a table held by the conflict detection unit according to the first embodiment in a case of two inputs and two outputs. The table 200 in FIG. 3 is a table for determining switching of a switch corresponding to one switch among a plurality of switches included in the blocking network switch 106 and a lane to be stalled.

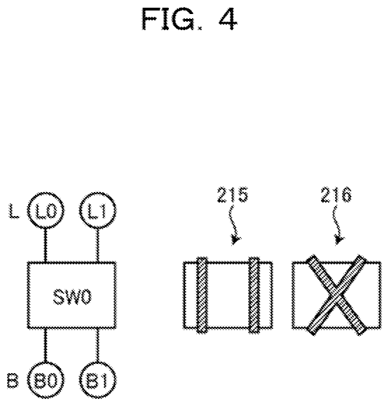

One of the blocking network switches 106 will be described. FIG. 4 is a diagram illustrating an overview of the one switch among the plurality of switches included in the blocking network switch. A switch SW0 corresponds to the one switch. L described in an upper part of the switch SW0 in view facing a paper surface represents terminals on the scalar load-store unit 104 and lanes L0 to L3 side (hereafter, referred to as “lane side terminals”), and B described in a lower part of the switch SW0 in view facing the paper surface represents the bank 170 side terminals. In the switch SW0, the lane L0 is coupled to a terminal on the left side in view facing the paper surface of the lane side terminals, and the lane L1 is coupled to a terminal on the right side of the lane side terminals. A path connected to a bank B0 is coupled to the terminal on the left side of the bank 170 side terminals in view facing the paper surface, and a path connected to the bank B1 is coupled to the terminal on the right side. A state 215 indicates a direct connection state in the switch SW0 in which the lane L0 and the bank B0 are coupled to each other and the lane L1 and the bank B1 are coupled to each other. A state 216 indicates an exchange state in the switch SW0 in which the lane L0 and the bank B1 are coupled to each other and the lane L1 and the bank B0 are coupled to each other. The switch SW0 is switched to the state 215 when a control signal having a value of 0 is input, and is switched to the state 216 when a control signal having a value of 1 is input.

The description is continued by returning to FIG. 3. For example, access destination information 211, priority lane information 212, a switch switching state 213, and a stalled lane 214 are registered in the table 200. For each of the lanes L0 and L1, the access destination information 211 represents access to the bank B0 with 0 and access to the bank B1 with 1. For example, when the values of each of the lanes L0 and L1 in the access destination information 211 are the same, this indicates that the destination bank 170 is the same and a bank conflict occurs. The priority lane information 212 represents that 0 gives priority to access of the lane L0 and 1 gives priority to access of the lane L1. The switch switching state 213 represents a value of a switch switching signal. For each of the lanes L0 and L1, the stalled lane 214 indicates that the lane is not stalled when the value is 0, and indicates that the lane is stalled when the value is 1.

For each of the lanes L0 and L1, the conflict detection unit 181 receives, as access information, an input of information indicating whether an access destination is the bank B0 or the bank B1. The conflict detection unit 181 holds information indicating which access of the lane L0 and the lane L1 is prioritized in advance. By using these pieces of information, the conflict detection unit 181 searches the table 200 and specifies the switch switching state and the stalled lane corresponding to these pieces of information from the switch switching state 213 and the stalled lane 214. The conflict detection unit 181 outputs information on the specified switch switching state and the specified stalled lane as the switch control information and the stalled lane information, respectively. Although the access control unit 108 determines a coupling path and a stall target by using a fixed priority order in the present embodiment, the priority order may be changed for each arbitration of the instruction output by using a predetermined algorithm.

When the search in the table 200 is performed by calculation, the conflict detection unit 181 determines the switch switching state and the stalled lane by using a logical expression indicated by the following expression (1). ctrl represents the switch switching state in the table 200 in FIG. 3, and the lanes L0 and L1 in a stall column represent stalled lanes. L0 and L1 in an access column represent values corresponding to the access destination information 211 corresponding to the input access information, and P represents a value corresponding to the priority lane information 212. A bar at an upper part of each sign represents an opposite value.

$$ctrl = L 0 \cdot \overline{P} + \overline{L 1} \cdot P \qquad ( 1 )$$

$$STALL L 0 = \overline{L 0} \cdot \overline{L 1} \cdot P + L 0 \cdot L 1 \cdot P$$

$$STALL L 1 = \overline{L 0} \cdot \overline{L 1} \cdot \overline{P} + L 0 \cdot L 1 \cdot \overline{P}$$

The description is continued by returning to FIG. 1. The pipeline control unit 182 receives an input of the stalled lane information from the conflict detection unit 181. The pipeline control unit 182 performs pipeline control for stalling one corresponding to the stalled lane instructed in the stalled lane information among the scalar load-store unit 104 and the lane processing units 150 to 153.

The switch control unit 183 receives an input of the switch control information from the conflict detection unit 181. According to each switch switching state instructed by the switch control information, the switch control unit 183 performs switch control for switching the blocking network switch 106.

Among the scalar load-store unit 104 and the lane processing units 150 to 153, the stalled one stops the output of the request corresponding to the instruction from the input side FIFO queue. Accordingly, the access control unit 108 may suppress a switch conflict in the blocking network switch 106 and a bank conflict in the multi-bank level 1 data cache 107.

Alternatively, the access control unit 108 may specify a conflict location and determine switch switching and a stall target such that a number of available lanes is as large as possible. For example, the switch switching and the stall target may be determined by the following procedure. The conflict detection unit 181 specifies a conflict location in the blocking network switch 106 and the multi-bank level 1 data cache 107 by using the access information and the information on the coupling path. The conflict detection unit 181 determines the switch switching and the stall target such that the number of coupling paths is as large as possible. The pipeline control unit 182 stalls the determined stall target. According to the determination by the conflict detection unit 181, the switch control unit 183 switches the blocking network switch 106.

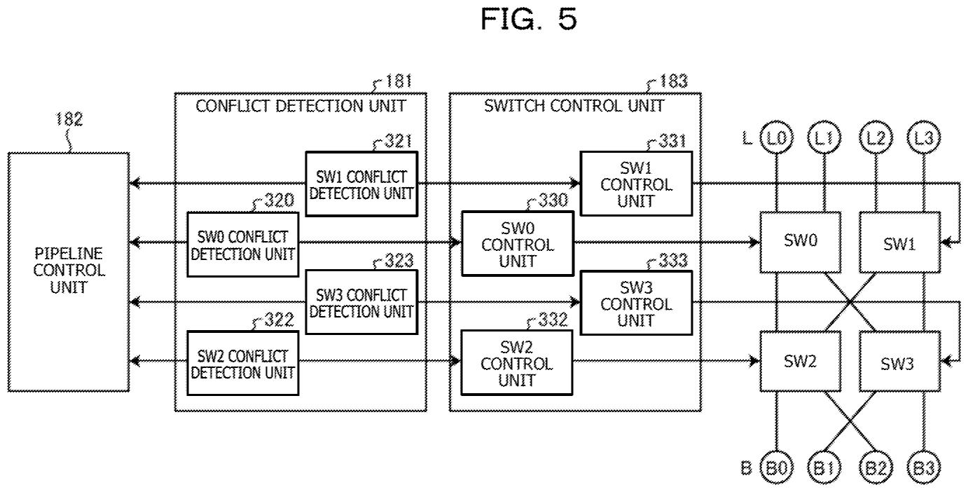

FIG. 5 is a diagram illustrating an example of a configuration of a conflict detection unit and a switch control unit. An example of the configurations of the conflict detection unit 181 and the switch control unit 183 will be described by taking, as an example, a case where the blocking network switch 106 includes switches SW0 to SW3.

The conflict detection unit 181 includes a SW0 conflict detection unit 320, a SW1 conflict detection unit 321, a SW2 conflict detection unit 322, and a SW3 conflict detection unit 323, which correspond to the switches SW0 to SW3, respectively. The switch control unit 183 includes a SW0 control unit 330, a SW1 control unit 331, a SW2 control unit 332, and a SW3 control unit 333 corresponding to the switches SW0 to SW3, respectively.

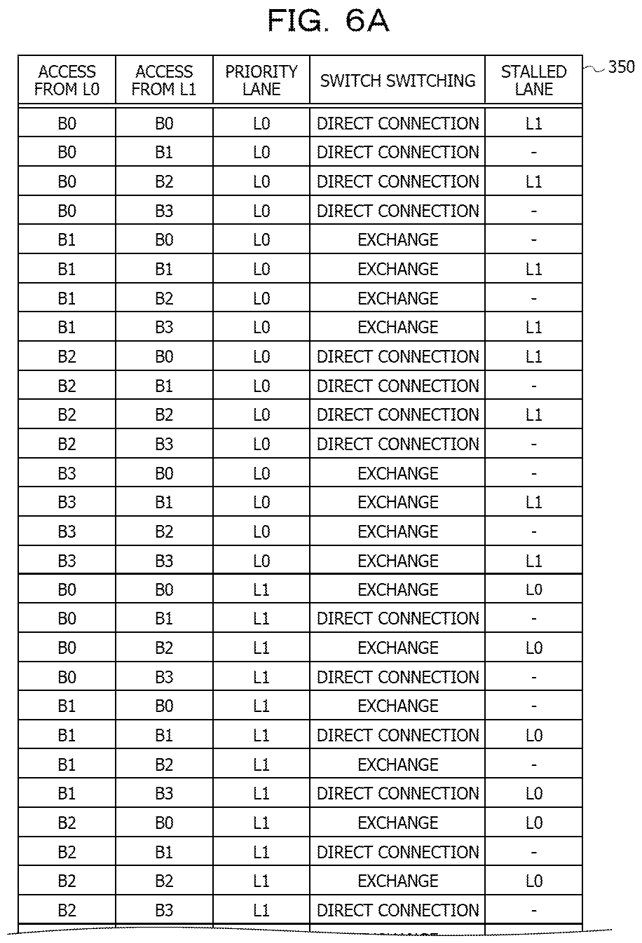

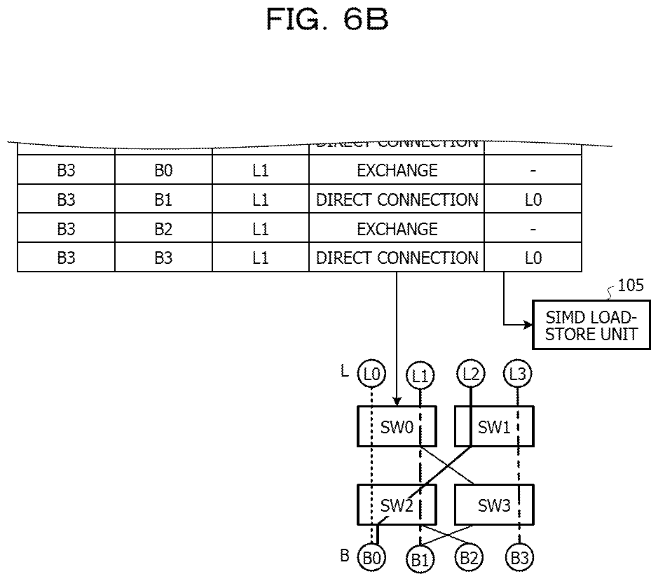

Each of the SW0 conflict detection unit 320, the SW1 conflict detection unit 321, the SW2 conflict detection unit 322, and the SW3 conflict detection unit 323 of the conflict detection unit 181 has a table such as a table 350 illustrated in FIGS. 6A and 6B.

FIGS. 6A and 6B are a diagram illustrating an example of a table included in the conflict detection unit in a case where switches are provided in two stages. The table 350 in FIGS. 6A and 6B is a table held by the switch SW0 in FIG. 5.

Combinations of the banks 170 of the access destinations of the lanes L0 and L1 and priority lanes are registered in the table 350. In the table 350, a switch switching state and a stalled lane corresponding to each combination of the access destination and the priority lane are registered.

Focusing on the SW0, the conflict detection unit 181 receives, as the access information, an input of information indicating to which of the banks B0 to B3 each of the lanes L0 and L1 is coupled. The conflict detection unit 181 holds a priority order of the lanes L0 and L1. By using these pieces of information, the conflict detection unit 181 searches the table 350 and specifies the switch switching state and the stalled lane corresponding to the access information and the priority order. The conflict detection unit 181 outputs switch control information to the switch control unit 183, and controls the switch SW0 according to the switch switching specified in accordance with the table 350. The conflict detection unit 181 outputs stalled lane information to the pipeline control unit 182, and controls the SIMD load-store unit 105 to stall a lane specified as the stalled lane in accordance with the table 350.

The description is continued by returning to FIG. 5. The SW0 conflict detection unit 320, the SW1 conflict detection unit 321, the SW2 conflict detection unit 322, and the SW3 conflict detection unit 323 hold the priority order of each lane. Each of the SW0 conflict detection unit 320, the SW1 conflict detection unit 321, the SW2 conflict detection unit 322, and the SW3 conflict detection unit 323 specifies a lane to which the concerned conflict detection unit itself is connected, and acquires access information including a destination of each lane. Each of the SW0 conflict detection unit 320, the SW1 conflict detection unit 321, the SW2 conflict detection unit 322, and the SW3 conflict detection unit 323 determines the switch switching state and the stalled lane of the corresponding switches SW0 to SW3.

The SW0 control unit 330, the SW1 control unit 331, the SW2 control unit 332, and the SW3 control unit 333 of the switch control unit 183 acquire switch control information for the corresponding switches SW0 to SW3 respectively. According to the switch control information, the SW0 control unit 330, the SW1 control unit 331, the SW2 control unit 332, and the SW3 control unit 333 perform switching of the corresponding switches SW0 to SW3.

The pipeline control unit 182 acquires stalled lane information from the SW0 conflict detection unit 320, the SW1 conflict detection unit 321, the SW2 conflict detection unit 322, and the SW3 conflict detection unit 323. The pipeline control unit 182 stalls any one of the lane processing units 150 and 151 corresponding to the lane designated as the stalled lane by each piece of stalled lane information.

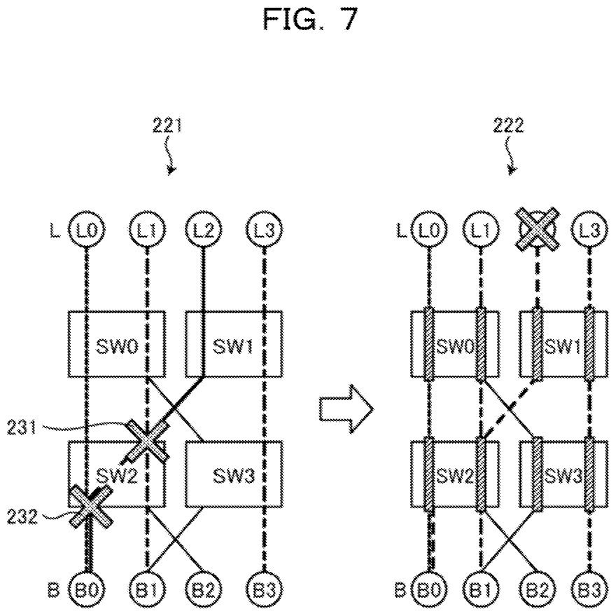

FIG. 7 is a diagram illustrating an example of determination of a switch switching state and a stalled lane according to the first embodiment. A state 221 indicates a coupling state in accordance with the access information, and a state 222 indicates a coupling state after executing the switch switching and stalling. The blocking network switch 106 includes the switches SW0 to SW3, and includes lane side terminals corresponding to the lanes L0 to L3 and bank 170 side terminals corresponding to the banks B0 to B3. A case where instructions are issued from the lane processing units 150 to 153 and the lane processing units 150 to 153 are coupled to the lane side terminals respectively corresponding to the lanes L0 to L3 will be described.

By using the access information acquired from an instruction stored at a head of the input side FIFO queue for each lane, the conflict detection unit 181 checks the state 221 that is the coupling state corresponding to the access information. The conflict detection unit 181 checks that a switch conflict occurs at a conflict location 231 and a conflict location 232 in the switch SW2.

By using the own table, the conflict detection unit 181 determines the switch switching state and the stalled lane. In this case, the conflict detection unit 181 determines that all of the switches SW0 to SW3 are in the direct connection state and that the lane L2 is the stalled lane. According to the determination by the conflict detection unit 181, the pipeline control unit 182 and the switch control unit 183 stall the lane processing unit 152 corresponding to the lane L2 and perform switching of the blocking network switch 106. Accordingly, the blocking network switch 106 is set to a switching state such as the state 222. In this case, access from the lane L2 is stopped, the lanes L0, L1, and L3 are connected to the banks B0, B1, and B3, respectively, and the instruction execution unit 10 may avoid a switch conflict in the blocking network switch 106.

The arithmetic execution unit 101 executes an arithmetic operation by using data stored in the scalar register file 102 and the vector register file 103.

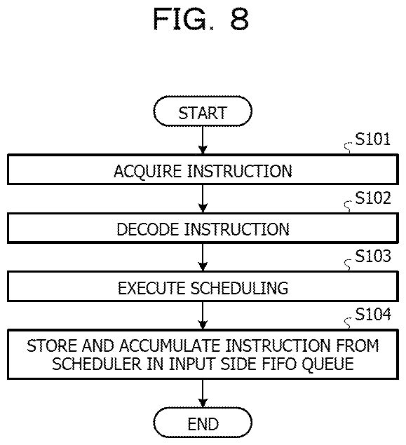

FIG. 8 is a flowchart of instruction fetch processing. Next, a flow of the instruction fetch processing will be described with reference to FIG. 8.

The instruction fetch unit 11 acquires a load instruction and a store instruction from the memory 2 (step S101).

Each of the instructions acquired from the instruction fetch unit 11 is decoded by the instruction decoding unit 12 (step S102).

The scheduler 13 receives an input of the decoded instruction from the instruction decoding unit 12. The scheduler 13 executes scheduling of each instruction (step S103). A case where the scheduler 13 stores the instructions subjected to the scheduling in the vector register file 103 will be described.

The scheduler 13 stores and accumulates scalar load-store instructions in the input side FIFO queue of the scalar load-store unit 104. SIMD load-store instructions are stored and accumulated in the input side FIFO queues of the lane processing units 150 to 153 of the SIMD load-store unit (step S104).

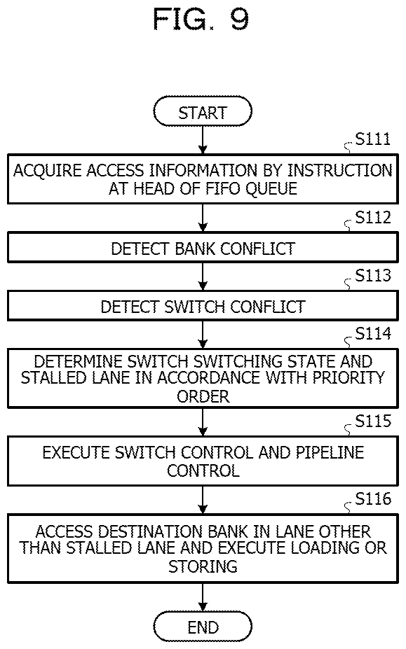

FIG. 9 is a flowchart of switch control and pipeline control by the access control unit according to the first embodiment. Next, a flow of switch control and stall control by the access control unit 108 according to the first embodiment will be described with reference to FIG. 9.

The conflict detection unit 181 acquires access information by an instruction at a head of the input side FIFO queue in each of the scalar load-store unit 104 and the lanes L0 to L3 (step S111).

Next, the conflict detection unit 181 detects a bank conflict by using the access information (step S112).

Next, the conflict detection unit 181 detects a switch conflict by using the access information and coupling information (step S113).

Next, the conflict detection unit 181 determines a switch switching state and a stalled lane in accordance with a priority order of access permission (step S114).

According to the switch switching state determined by the conflict detection unit 181, the switch control unit 183 executes switch control for switching the blocking network switch 106. The pipeline control unit 182 executes pipeline control for stalling any one or a plurality of the scalar load-store unit 104 and the lanes L0 to L3 corresponding to the lane determined as the stalled lane by the conflict detection unit 181 (step S115).

After that, the scalar load-store unit 104 and the lanes L0 to L3 access a destination bank in a lane other than the stalled lane of the pipeline and execute data loading or data storing (step S116).

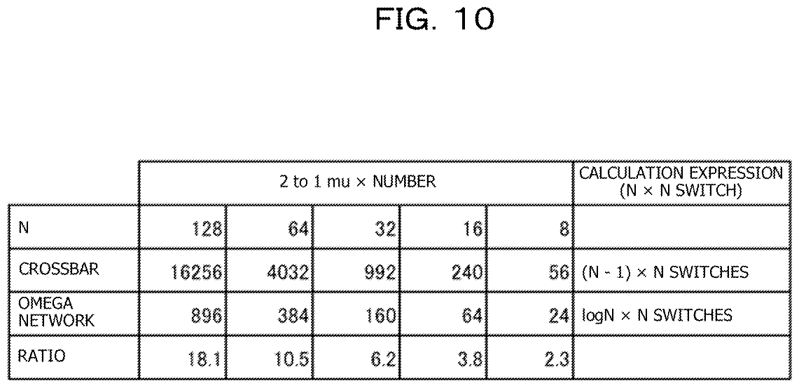

FIG. 10 is a diagram illustrating a comparison between circuit scales of a crossbar switch and an omega network switch. FIG. 10 indicates a circuit scale converted by a number of two-inputs one-output multiplexers (mu×2).

For example, in a case of an 8×8 switch, in the case of the crossbar switch, since seven mu×2 are provided per one output and eight sets of them are arranged, a total of 56 mu×2 are provided. By contrast, in the case of the omega network switch, since two mu×2 are provided per one cross point and twelve sets of them are arranged, a total of 24 mu×2 are provided. In this case, a ratio between the circuit scales of the crossbar switch and the omega network switch is 56/24=2.3 times. For example, in this case, the circuit scale may be reduced to 1/2.3 in the CPU 1 according to the present embodiment as compared with the related art.

For example, in a case of a 128×128 switch, in the case of the crossbar switch, a total of 16256 mu×2 are provided. By contrast, in the case of the omega network switch, a total of 896 mu×2 are provided. In this case, a ratio between the circuit scales of the crossbar switch and the omega network switch is 16256/896=18 times. For example, in this case, the circuit scale may be reduced to 1/18 in the CPU 1 according to the present embodiment as compared with the related art.

As described above, the CPU according to the present embodiment includes a blocking network between the plurality of load-store units respectively corresponding to the plurality of lanes of the pipeline and the multi-bank level 1 data cache. The CPU according to the present embodiment detects a switch conflict and a bank conflict based on access information by each instruction, and determines switch switching and stalling of the lane in the blocking network such that no conflict occurs. The CPU according to the present embodiment controls the load-store unit and the multi-bank level 1 data cache. Accordingly, the circuit scale may be reduced by using the blocking network, and an occurrence of a conflict may be avoided by stalling. Therefore, it is possible to reduce the circuit scale while suppressing degradation in a processing performance of the CPU having the multi-bank level 1 data cache.

### Second Embodiment

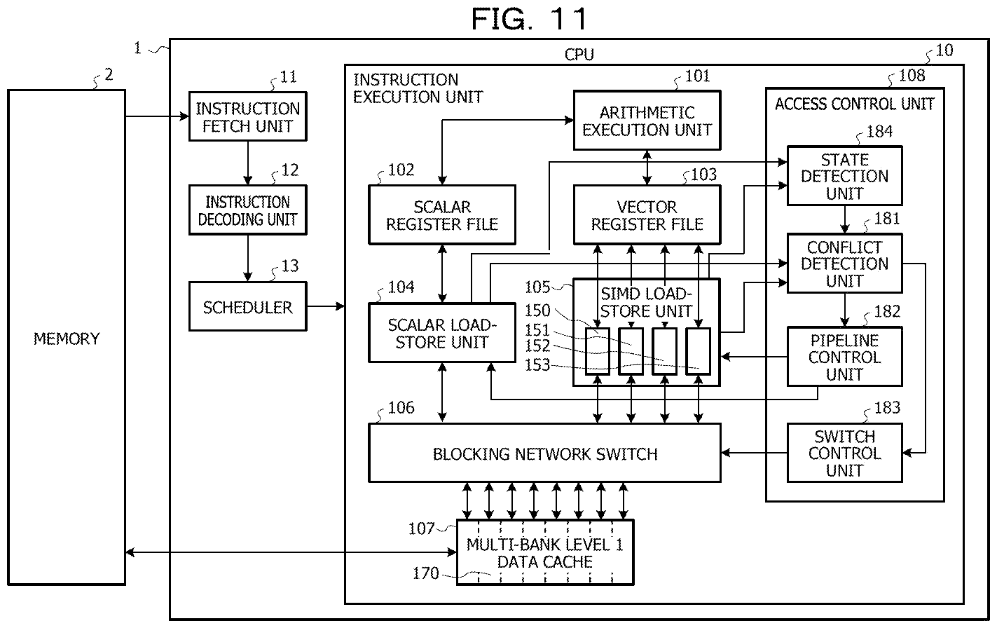

FIG. 11 is a block diagram of a CPU according to a second embodiment. A CPU 1 according to the present embodiment is different from that of the first embodiment in that a stalled lane is determined in consideration of the number of instructions held by the FIFO queue, for example, a clogging degree of instructions in each lane. As illustrated in FIG. 11, the CPU 1 according to the present embodiment further includes a state detection unit 184 in the access control unit 108 in addition to each unit in the first embodiment. In the following description, description will be omitted for the operation of each unit similar to that in the first embodiment.

For each cycle, the state detection unit 184 acquires the number of instructions accumulated in the input side FIFO queue of each of the scalar load-store unit 104 and the lane processing units 150 to 153 as information representing the clogging degree of each lane of the pipeline. Hereinafter, the number of held instructions of the input side FIFO queue of each of the scalar load-store unit 104 and the lane processing units 150 to 153 is referred to as a “number of held instructions for each lane”. Next, the state detection unit 184 determines a priority order for each lane in accordance with the number of held instructions for each lane. For example, the priority order of each lane may be represented by using the number of held instructions as it is. The state detection unit 184 outputs the priority order obtained from the number of held instructions to the conflict detection unit 181.

The conflict detection unit 181 holds an initial priority order that is an initial value of a priority order of access permission for each lane of a predetermined pipeline. The conflict detection unit 181 receives an input of the priority order obtained from the number of held instructions for each lane from the state detection unit 184. Next, in a case where there are lanes having the same priority order among the priority orders obtained from the number of held instructions for each lane, the conflict detection unit 181 determines the priority order of these lanes in accordance with the initial priority order, and determines the priority order of each lane.

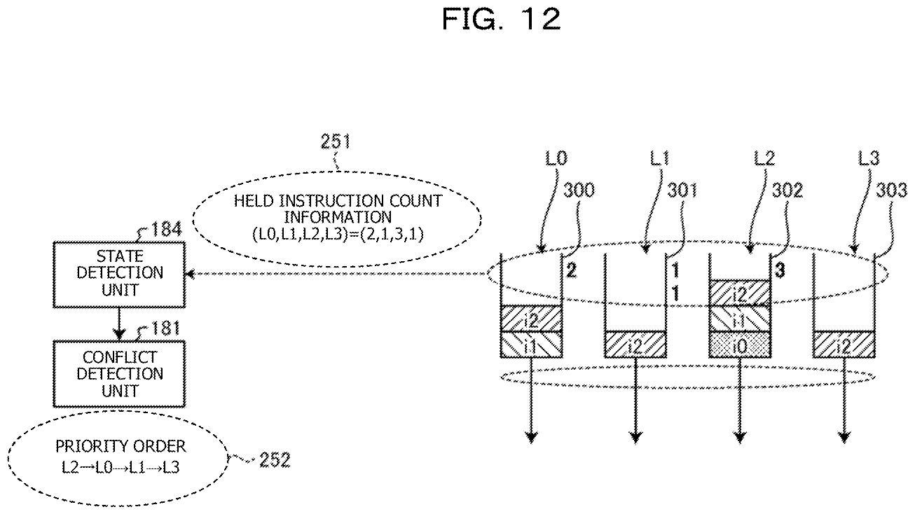

FIG. 12 is a diagram illustrating an example of determination processing of the priority order for each lane of the pipeline according to the second embodiment. A case where instructions are output from the lane processing units 150 to 153 respectively corresponding to the lanes L0 to L3 will be described. The lane processing units 150 to 153 respectively have input side FIFO queues 300 to 303.

In the case of FIG. 12, the number of held instructions of the FIFO queue 300 is 2. The number of held instructions of the FIFO queue 301 is 1. The number of held instructions of the FIFO queue 302 is 3. The number of held instructions of the FIFO queue 303 is 1. Accordingly, the state detection unit 184 acquires held instruction count information 251 indicating the numbers of held instructions of the lanes L0 to L3 corresponding to the lane processing units 150 to 153. In FIG. 12, the held instruction count information 251 is represented as (L0, L1, L1, L3)=(2, 1, 3, 1). The state detection unit 184 outputs the held instruction count information 251 as it is as the priority order to the conflict detection unit 181. The conflict detection unit 181 holds the priority order of the lanes L0, L1, L1, and L3 in descending order of priorities as an initial priority order.

Based on the priority order ((L0, L1, L1, L3 )=(2, 1, 3, 1)) obtained from the number of held instructions acquired by the state detection unit 184, the conflict detection unit 181 checks that the number of held instructions of the lane L2 is the maximum and then the number of held instructions of the lane L0 is the second largest. The conflict detection unit 181 checks that the numbers of held instructions of the lane L1 and the lane L3 are the same value at the minimum. In this case, since the numbers of held instructions of the lane L1 and the lane L3 are the same, the conflict detection unit 181 sets the priority order of the lane L1 higher than the priority order of the lane L3 in accordance with the initial priority order. Accordingly, the conflict detection unit 181 calculates a priority order 252 such that the priority order decreases in the order of the lane L1, the lane L0, the lane L1, and the lane L3. The conflict detection unit 181 determines a switch switching state and a stalled lane in accordance with the access information and the priority order 252.

According to the switch switching state determined by the conflict detection unit 181, the switch control unit 183 executes switch control for switching the blocking network switch 106. According to the stalled lane determined by the conflict detection unit 181, the pipeline control unit 182 executes pipeline control for selecting a stall target from among the scalar load-store unit 104 and the lanes L0 to L3 and stalling.

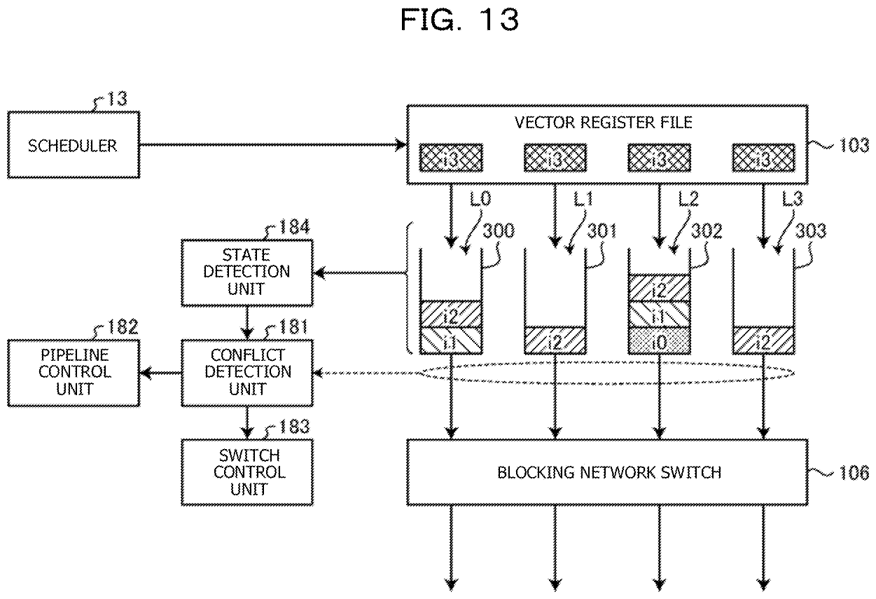

FIG. 13 is a diagram illustrating an overview of access control processing performed by an access control unit according to the second embodiment. Next, an overview of the access control processing by the access control unit 108 according to the present embodiment will be described together with reference to FIG. 13.

The scheduler 13 stores instructions i3 for the lanes L0 to L3 respectively corresponding to the lane processing units 150 to 153 in FIFO queues at entrances of the lane processing units 150 to 153.

The state detection unit 184 acquires the number of held instructions of each of the FIFO queues 300 to 303 storing the instruction i3. The state detection unit 184 notifies the conflict detection unit 181 of a priority order obtained from the number of held instructions for each lane.

By using the priority order obtained from the number of held instructions notified from the state detection unit 184 and an initial priority order, the conflict detection unit 181 determines the priority order of each lane at that time point. Next, the conflict detection unit 181 acquires access information by an instruction i1 at a head of the FIFO queue 300, an instruction i2 at a head of the FIFO queue 301, an instruction i0 at a head of the FIFO queue 302, and an instruction i2 at a head of the FIFO queue 303. By using the access information and the determined priority order of each lane, the conflict detection unit 181 determines a switch switching state and a stalled lane. After that, the conflict detection unit 181 notifies the switch control unit 183 of switch control information for instructing switch switching. The conflict detection unit 181 notifies the pipeline control unit 182 of stalled lane information indicating a stalled lane.

According to a switch switching instruction included in the switch control information, the switch control unit 183 switches the blocking network switch 106. The pipeline control unit 182 stalls any one of the lane processing units 150 to 153 corresponding to the stalled lane instructed by the stalled lane information.

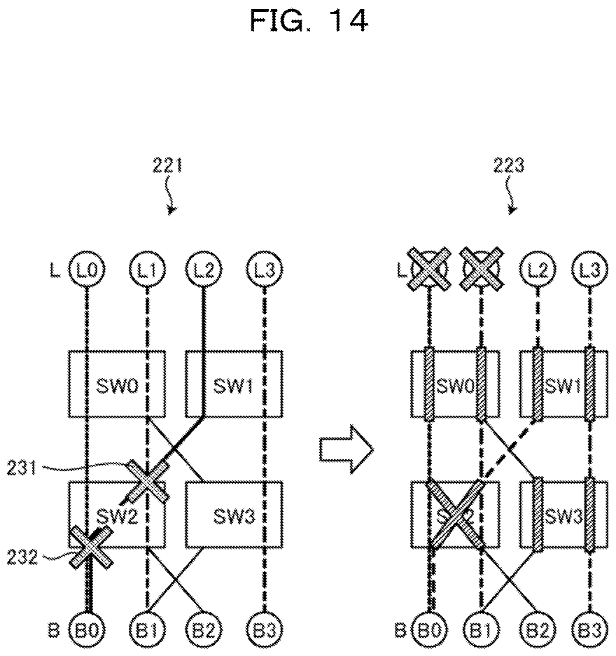

FIG. 14 is a diagram illustrating an example of determination of the switch switching state and the stalled lane in consideration of the number of held instructions. A state 221 indicates a coupling state according to the access information, and a state 223 indicates a coupling state after executing the switch switching and stalling in consideration of the number of held instructions. The blocking network switch 106 includes the switches SW0 to SW3, and includes lane side terminals corresponding to the lanes L0 to L3 and bank 170 side terminals corresponding to the banks B0 to B3. The lane processing units 150 to 153 are coupled to the lane side terminals corresponding to the lanes L0 to L3, respectively.

By using the access information acquired from an instruction stored at a head of the input side FIFO queue for each lane, the conflict detection unit 181 checks the state 221 that is the coupling state corresponding to the access information. The conflict detection unit 181 checks that a switch conflict occurs at a conflict location 231 and a conflict location 232 in the switch SW2.

The state detection unit 184 acquires the numbers of held instructions of the lane processing units 150 to 153. A case where the number of held instructions in the lane processing unit 152 is the maximum will be described. By using the priority order obtained from the number of held instructions and the initial priority order, the state detection unit 184 determines the priority order of the lanes L0 to L3. In this case, since the number of held instructions of the lane processing unit 152 is the maximum, the state detection unit 184 sets the priority order of the corresponding lane L2 to be the highest. By using the priority order obtained from the number of held instructions and the initial priority order, the conflict detection unit 181 calculates the priority order of the lanes L0 to L3. After that, the conflict detection unit 181 uses the calculated priority order and its own table to determine the switch switching state and the stalled lane.

In this case, since the priority order of the lane processing unit 152 is the highest, the conflict detection unit 181 sets the lanes L0 and L1 as stalled lanes in order to avoid conflicts at the conflict locations 231 and 232 and to allow access of the lane L2. The conflict detection unit 181 determines that the switches SW1 and SW3 are in the direct connection state and the switch SW2 is in the exchange state. According to the determination by the conflict detection unit 181, the pipeline control unit 182 and the switch control unit 183 stall the lane processing units 150 and 151 corresponding to the lanes L0 and L1, and perform switching of the blocking network switch 106. Accordingly, the blocking network switch 106 is set to the switching state indicated by the state 223.

In this case, since there is no access from the lanes L0 and L1, the lane L2 is connected to the bank B0, the lane L3 is connected to the bank B3, and the instruction execution unit 10 may avoid a switch conflict in the blocking network switch 106. As described above, by changing the priority in accordance with the number of held instructions for each lane, there may be a case where the conflict detection unit 181 according to the present embodiment performs selection different from selection of the stalled lane using a simple priority order as in the first embodiment.

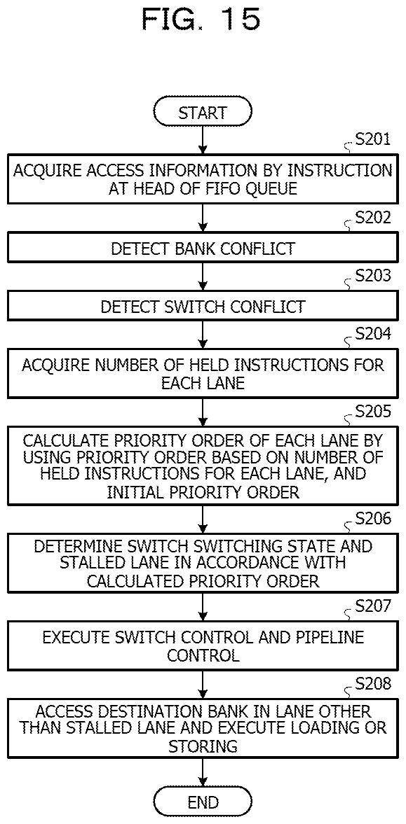

FIG. 15 is a flowchart of switch control and pipeline control by the access control unit according to the second embodiment. Next, a flow of switch control and pipeline control by the access control unit 108 according to the second embodiment will be described with reference to FIG. 15.

The conflict detection unit 181 acquires access information by the instruction at the head of the input side FIFO queue in each of the scalar load-store unit 104 and the lanes L0 to L3 (step S201).

Next, the conflict detection unit 181 detects a bank conflict by using the access information (step S202).

Next, the conflict detection unit 181 detects a switch conflict by using the access information and coupling information (step S203).

The state detection unit 184 checks the number of instructions accumulated in the input side FIFO queue of each of the scalar load-store unit 104 and the lane processing units 150 to 153, and acquires the number of held instructions for each lane (step S204).

The conflict detection unit 181 acquires a priority order obtained from the number of held instructions from the state detection unit 184. By using the priority order obtained from the number of held instructions and an initial priority order, the conflict detection unit 181 calculates a priority order of each lane (step S205).

Next, the conflict detection unit 181 determines a switch switching state and a stalled lane in accordance with the information on the detected conflict location and the calculated priority order (step S206).

According to the switch switching state determined by the conflict detection unit 181, the switch control unit 183 executes switch control for switching the blocking network switch 106. The pipeline control unit 182 executes pipeline control for stalling any one of the scalar load-store unit 104 and the lane processing units 150 to 153 corresponding to a lane determined as the stalled lane by the conflict detection unit 181 (step S207).

After that, the scalar load-store unit 104 and the lanes L0 to L3 access a destination bank in a lane other than the stalled lane of the pipeline and execute data loading or data storing (step S208).

Although the conflict detection unit 181 determines the priority order of access permission for each lane by prioritizing a clogging degree of the pipeline in the above description, the priority order may be determined so as to increase the number of available lanes by simultaneously using access information and configuration information of the switches.

As described above, the CPU according to the present embodiment determines the stalled lane and the switch switching by increasing the priority order of access permission for each lane in descending order of the number of instructions accumulated in the FIFO queue. With the CPU, for example, when a specific lane in the pipeline is significantly delayed, there is a risk that a FIFO queue may overflow and the entire pipeline may stall, leading to degradation in performance. By preferentially selecting the delayed lane in consideration of the clogging degree of the entire pipeline, the CPU according to the present embodiment may optimize the entire pipeline. Accordingly, it is possible to reduce the circuit scale while suppressing degradation in the processing performance of the CPU having the multi-bank level 1 data cache.

### FIRST MODIFICATION EXAMPLE

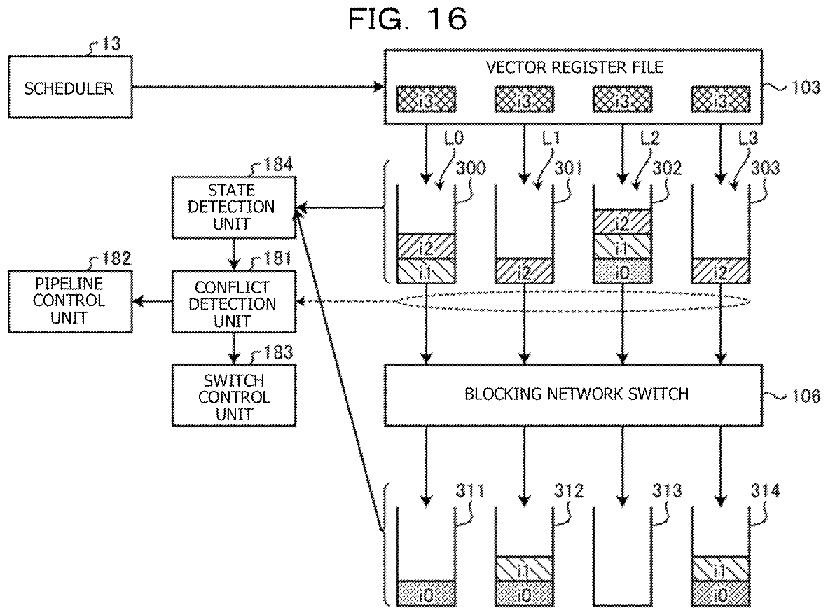

Although the conflict detection unit 181 determines the priority order of access permission for each lane by using the number of held instructions of the input side FIFO queue in the second embodiment, the priority order may be determined by using information other than this. For example, the conflict detection unit 181 may determine the priority order by taking into consideration the number of held instructions of the output side FIFO queue. FIG. 16 is a diagram illustrating an example of a case where a priority order is determined by using the number of held instructions of each of the input side and output side FIFO queues. Hereinafter, with reference to FIG. 16, priority order determination processing using the number of held instructions of each of the input side and output side FIFO queues will be described. A case where instructions are input to the lane processing units 150 to 153 will be described.

The state detection unit 184 acquires the number of held instructions of the input side FIFO queue of each of the lane processing units 150 to 153. The state detection unit 184 acquires the number of held instructions of the output side FIFO queue of each of the lane processing units 150 to 153.

Next, the state detection unit 184 expresses the priority order of each lane by the number of held instructions of the input side FIFO queue. For example, in the case of FIG. 16, the state detection unit 184 represents the priority order of each lane as (L0, L1, L1, L3 )=(2, 1, 3, 1).

Next, the state detection unit 184 divides the numbers of held instructions of the output side FIFO queues into two or more and less than two, and represents as priorities in two high and low stages. For example, in the case of FIG. 16, the state detection unit 184 represents the priority order of each lane as (L0, L1, L1, L3 )=(0, 1, 0, 1). In this case, 0 represents a low priority and 1 represents a high priority.

The state detection unit 184 calculates a priority order obtained by combining the priority order based on the number of held instructions of the input side FIFO queue and the priority order based on the number of held instructions of the output side FIFO queue. For example, the state detection unit 184 sets the priority order based on the number of held instructions of the output side FIFO queue as a high priority, and concatenates values obtained by representing each of the priority orders in binary numbers to set as the priority order of each lane. For example, in the case of FIG. 16, since the priority order based on the number of held instructions of the input side FIFO queue of the lane L2 is 3, the priority order is 011 when represented by the binary number. Since the priority order based on the number of held instructions of the output side FIFO queue of the lane L2 is 0, the priority order is 0 when represented by the binary number. Accordingly, the state detection unit 184 sets the priority order of the lane L2 to 0011 by putting the binary number representing the priority order based on the number of held instructions of the output side FIFO queue in front and concatenating them to each other. Similarly, the state detection unit 184 sets the priority order of the lane L0 to 0010, the priority order of the lane L1 to 1001, and the priority order of the lane L3 to 1001. After that, the state detection unit 184 outputs the priority order of each lane to the conflict detection unit 181.

The conflict detection unit 181 receives an input of the priority order of each lane from the state detection unit 184. By using the priority order of each lane acquired from the state detection unit 184 and the initial priority order, the conflict detection unit 181 determines the priority order of each lane. For example, in a case where 0010, 1001, 0011, and 1001 are acquired as the priority orders of the lanes L0 to L1, respectively, the conflict detection unit 181 determines the priority order of each lane such that the priority order decreases in the order of the lane L1, the lane L3, the lane L2, and the lane L0. According to the access information and the priority order of each lane, the conflict detection unit 181 determines switch switching and a stalled lane.

In the present modification example, the state detection unit 184 sets the priority order based on the number of held instructions of the output side FIFO queue to the two high and low stages, but the present modification example is not limited to this, and the number of stages may be increased, or the priority order may be represented by the number of held instructions as in the input side. Conversely, the state detection unit 184 may represent the priority order based on the number of held instructions of the output side FIFO queue by a predetermined number of stages.

The state detection unit 184 may notify the conflict detection unit 181 of the priority order based on the number of held instructions of the output side FIFO queue without notifying the priority order based on the number of held instructions of the input side FIFO queue. In this case, the conflict detection unit 181 determines switch switching and a stalled lane in accordance with the priority order based on the number of held instructions of the output side FIFO queue.

As described above, the CPU according to the present embodiment determines the priority order of each lane based on the numbers of instructions accumulated in both the input side and output side FIFO queues, and determines the stalled lane and the switch switching. As described above, by considering the numbers of instructions accumulated in both the input side and output side FIFO queues, it is possible to select an optimum stalled lane by viewing the entire pipeline. Accordingly, the CPU according to the present embodiment may reduce the circuit scale while suppressing degradation in the processing performance of the CPU having the multi-bank level 1 data cache.

### SECOND MODIFICATION EXAMPLE

Although the stalled lane is determined by normally prioritizing the clogging degree of the pipeline in the second embodiment, the stalled lane may be determined by balancing the clogging degree of the pipeline with the number of available lanes.

For example, the conflict detection unit 181 has a threshold of the number of held instructions for determining whether to prioritize the clogging degree of the pipeline in advance. By referring to the priority order of each lane represented by the number of held instructions notified by the state detection unit 134, the conflict detection unit 181 determines whether the number of held instructions equal to or greater than the threshold exists.

When all the numbers of held instructions are less than the threshold, the conflict detection unit 181 determines the priority order of each lane based on the access information such that the number of available lanes is as large as possible. In this case, the conflict detection unit 181 may determine the priority order by using an algorithm that increases the number of available lanes as large as possible, and the number of available lanes does not have to be maximized. By contrast, when the number of held instructions equal to or greater than the threshold exists, the conflict detection unit 181 determines the priority order of each lane by using the number of held instructions of the input side FIFO queue and the initial priority order.

For example, a case where the threshold is 3 and the instructions are input to the lane processing units 150 to 153 will be described. When the priority order based on the numbers of held instructions of the input side FIFO queues is (L0, L1, L1, L3 )=(2, 1, 3, 1), the maximum value of the number of held instructions is 3, and the number of held instructions equal to or greater than the threshold exists. Accordingly, based on the priority order based on the numbers of held instructions of the input side FIFO queues, the conflict detection unit 181 determines the priority order of each lane such that the priority order decreases in the order of the lane L2, the lane L0, the lane L1, and the lane L3.

By contrast, when the priority order based on the numbers of held instructions of the input side FIFO queues is (L0, L1, L1, L3 )=(2, 1, 2, 1), the maximum value of the number of held instructions is 2, and all the numbers of held instructions are less than the threshold. Accordingly, the conflict detection unit 181 does not use the priority order based on the number of held instructions of the input side FIFO queue, but determines the priority order of each lane based on the access information such that the number of available lanes is as large as possible.

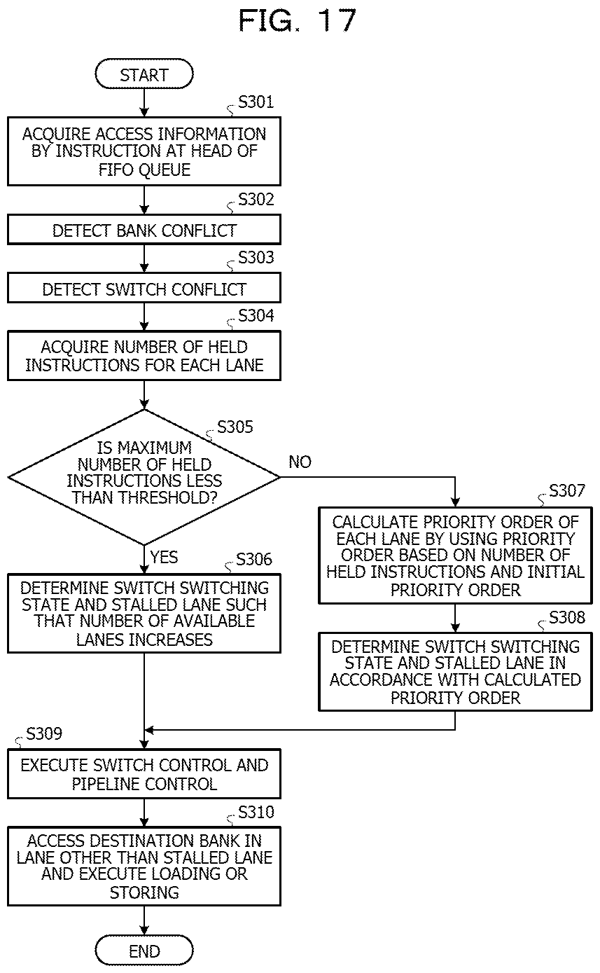

FIG. 17 is a flowchart of switch control and pipeline control by an access control unit according to a second modification example. Next, a flow of switch control and pipeline control by the access control unit 108 according to the second modification example will be described with reference to FIG. 17.

The conflict detection unit 181 acquires access information by the instruction at the head of the input side FIFO queue in each of the scalar load-store unit 104 and the lanes L0 to L3 (step S301).

Next, the conflict detection unit 181 detects a bank conflict by using the access information (step S302).

Next, the conflict detection unit 181 detects a switch conflict by using the access information and coupling information (step S303).

The state detection unit 184 checks the number of instructions accumulated in the input side FIFO queue of each of the scalar load-store unit 104 and the lane processing units 150 to 153, and acquires the number of held instructions for each lane (step S304).

The conflict detection unit 181 acquires a priority order represented by the number of held instructions from the state detection unit 184. The conflict detection unit 181 determines whether the maximum number of held instructions is less than a threshold (step S305).

When the maximum number of held instructions is less than the threshold (step S305: affirmative), the conflict detection unit 181 determines switch switching and a stalled lane in accordance with information on a detected conflict location and an initial priority order of access permission (step S306). After that, the processing of the switch control and the stall control proceeds to step S309.

By contrast, when the maximum number of held instructions is equal to or greater than the threshold (step S305: negative), the conflict detection unit 181 calculates the priority order of each lane by using the priority order based on the number of held instructions and the initial priority order (step S307).

Next, the conflict detection unit 181 determines a switch switching state and a stalled lane in accordance with the information on the detected conflict location and the calculated priority order (step S308). After that, the processing of the switch control and the stall control proceeds to step S309.

After that, according to the switch switching state determined by the conflict detection unit 181, the switch control unit 183 executes switch control for switching the blocking network switch 106. The pipeline control unit 182 executes pipeline control for stalling any one of the scalar load-store unit 104 and the lane processing units 150 to 153 corresponding to the stalled lane determined by the conflict detection unit 181 (step S309).

After that, the scalar load-store unit 104 and the lanes L0 to L3 access a destination bank in a lane other than the stalled lane of the pipeline and execute data loading or data storing (step S310).

As described above, the CPU according to the present embodiment determines the stalled lane and the switch switching by balancing the priority order based on the number of instructions accumulated in the FIFO queue and the priority order in which the number of available lanes increases. Accordingly, it is possible to reduce the circuit scale while suppressing degradation in the processing performance of the CPU having the multi-bank level 1 data cache.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a storage apparatus including a plurality of banks used as respective separate storage regions;
a pipeline having a plurality of lanes in each of which processing of an instruction for reading or writing data from or to the bank is performed;
a plurality of instruction processing circuits that are respectively disposed in the lanes, each access any of the banks in accordance with the instruction processed in the corresponding lane, and each execute reading or writing of data;
a blocking network switch configured to selectively couple the instruction processing circuit to any one of the banks by switching a coupling path;
a conflict detection circuit configured to, in a case where two or more of the instruction processing circuits access the bank, detect a conflict location of the access based on information on an access destination and information on the coupling path of the blocking network switch, and determine a switching state of the blocking network switch and a stalled lane in which the processing is to be stopped from among the plurality of lanes based on the detected conflict location;
a pipeline control circuit configured to perform pipeline control for stopping the access to the bank from the instruction processing circuit corresponding to the stalled lane determined by the conflict detection circuit; and
a switch control circuit configured to switch the blocking network switch in accordance with the switching state determined by the conflict detection circuit.

2. The information processing apparatus according to claim 1, wherein
the conflict detection circuit detects both a bank conflict in the storage apparatus and a switch conflict in the blocking network switch.

3. The information processing apparatus according to claim 1, wherein
each of the plurality of instruction processing circuits has a queue that processes the instructions in an input order, and
the conflict detection circuit determines the switching state of the blocking network switch and the stalled lane in which the processing is to be stopped based on a number of held instructions accumulated in the queue.

4. The information processing apparatus according to claim 3, wherein
the conflict detection circuit determines the switching state of the blocking network switch and the stalled lane in which the processing is to be stopped by giving a priority order for permitting the access to the lane corresponding to the instruction processing circuit such that an order increases as the number of held instructions stored in the queue increases.

5. The information processing apparatus according to claim 3, wherein
the conflict detection circuit determines, in a case where a maximum value of the number of held instructions is equal to or greater than a threshold, the switching state of the blocking network switch and the stalled lane in which the processing is to be stopped based on the number of held instructions accumulated in the queue.

6. A method of processing information comprising:
detecting, by an information processing apparatus including:
a storage apparatus including a plurality of banks used as respective separate storage regions;
a pipeline having a plurality of lanes in each of which processing of an instruction for reading or writing data from or to the bank is performed;
a plurality of instruction processing circuits that are respectively disposed in the lanes, each access any of the banks in accordance with the instruction processed in the corresponding lane, and each execute reading or writing of data; and
a blocking network switch configured to selectively couple the instruction processing circuit to any one of the banks by switching a coupling path,
in a case where two or more of the instruction processing circuits access the bank, a conflict location of the access based on information on an access destination and information on the coupling path of the blocking network switch;
determining a switching state of the blocking network switch and a stalled lane in which the processing is to be stopped from among the plurality of lanes based on the detected conflict location;
performing pipeline control for stopping the access to the bank from the instruction processing circuit corresponding to the stalled lane; and
switch the blocking network switching in accordance with the switching state.
